(19) United States
(12) Patent Application Publication
(10) Pub. No.: US 2025/0364877 A1
(43) Pub. Date: Nov. 27, 2025

(54) ELEMENTARY LAMINATION FOR HELICOIDAL STACK

(71) Applicant: SAFRAN ELECTRONICS & DEFENSE, Paris (FR)

(72) Inventors: Bernard RABRET, MOISSY-CRAMAYEL (FR); Blaise André Michel LAPÔTRE, MOISSY-CRAMAYEL (FR)

(73) Assignee: SAFRAN ELECTRONICS & DEFENSE, Paris (FR)

(21) Appl. No.: 18/998,606

(22) PCT Filed: Jul. 26, 2023
(86) PCT No.: PCT/FR2023/051179

§ 371 Date: Jan. 27, 2025

(51) Int. Cl. H02K 11/21; G01D 5/14; H02K 1/22; H02K 15/0273

(52) U.S. Cl. CPC H02K 11/21; G01D 5/14; H02K 1/22; H02K 15/0273

(57) ABSTRACT

The invention relates to an elementary lamination (10) in the form of a hollow disc, characterized in that the outside edge comprises a peripheral portion of said elementary lamination which has at least one structured section having a periodic structure (21) comprising a succession of periodicity elements, said periodic structure (21) being configured for aligning said elementary lamination in a helicoidal lamination stack (30), the peripheral portion further comprising at least one non-structured section (22), an orientation slot (23) being formed in the at least one non-structured section (22), said orientation slot being asymmetrical and/or closer to a periodic structure (21) on a first side of said non-structured section (22) than to the periodic structure (21) on a second side opposite from the first side of said non-structured section (22).

### FIELD OF THE INVENTION

This invention relates to an elementary lamination for a helical stack for application in a resolver or a rotary electric machine such as a motor. The invention also relates to a stack of elementary laminations for the manufacturing of a rotor for a resolver or a rotary electric machine.

### PRIOR ART

This invention is used for the production of variable-reluctance resolvers. A resolver is a type of sensor making it possible to accurately measure the speed and angle of rotation of an electric motor. They can in particular be found in all machines with electric motors, for example aeronautical actuators or optronics systems. A variable-reluctance resolver can also be used as a sensor to return an item of position information (for example, the gas throttles, flaps, or ailerons.)

A variable-reluctance resolver comprises a rotary central part, known as the rotor, and a fixed outer part, known as the stator. The rotor and the stator are composed of stacks of ferromagnetic laminations.

The rotor comprises a core formed of a plurality of stacked elementary plates or laminations. The elementary laminations are typically made of a ferromagnetic material having small hysteresis cycles. Each elementary lamination takes the form of a disc of hollow sheet metal, the circumference of which is essentially circular.

Such elementary laminations may be punched in a press or be cut out by electrical discharge machining, and are then stacked on top of one another to form the core.

In certain rotor cores, the elementary laminations are angularly offset with respect to a central axis of the circumference of each lamination, with respect to one another, to take into account any anisotropies of the lamination material resulting from the production process, for example rolling at a particular orientation. The angular offset moreover makes it possible to distribute any defects arising from the manufacturing of each elementary lamination, and to increase the accuracy of the device.

The U.S. Pat. No. 6,002,191 A makes provision for a stacking technique for manufacturing a rotor core comprising a stack of elementary laminations. This technique uses a key inserted into a slot arranged in the circumference of each elementary lamination, to form a passage for electric cables. However, certain elementary laminations do not comprise such slots. In addition, the technique cannot be used for angles of inclination greater than a few degrees. Due to the fact that this technique requires a retaining device in the form of a cylinder inserted into the center of the elementary laminations, it is not usable for elementary laminations having a non-circular inner hollow.

### SUMMARY OF THE INVENTION

An aim of the invention is to make provision for an elementary lamination which can have an inner hollow of any geometry, circular or otherwise, configured to be aligned in a helical stack of laminations uniformly and rotationally offset by a predetermined angle with respect to a central axis of the stack, with respect to the other elementary laminations present in the stack.

For this purpose, the invention makes provision for an elementary lamination in the shape of a disc, characterized in that a peripheral portion of said elementary lamination comprises at least one structured section having a periodic structure comprising a succession of periodicity elements, said periodic structure being configured to align said elementary lamination in a helical stack of laminations, the peripheral portion further comprising at least one unstructured section (22), an orientation slot (23) being arranged in the at least one unstructured section (22), said orientation slot being asymmetrical and/or closer to a periodic structure (21) on a first side of said unstructured section (22) than to the periodic structure (21) on a second side opposite the first side of said unstructured section (22).

Such elementary laminations may be stacked and angularly offset with respect to one another by any angle, even a wide angle for example greater than 150 for a height of a few millimeters.

Advantageously, the periodic structure comprises recesses extending in a radial direction of the disc.

Preferably, the peripheral portion comprising the at least one structured section further comprises at least one unstructured section.

In certain embodiments, the peripheral portion comprising the at least one structured section is the outer edge of the disc.

In other embodiments, the elementary lamination further includes an inner hollow, in which the peripheral portion comprising the at least one structured section is the inner edge of the hollow disc.

Advantageously, the elementary lamination comprises two structured sections having a periodic structure, and two unstructured sections.

The invention also relates to a stack of laminations comprising a plurality of elementary laminations as described above, stacked coaxially, a first elementary lamination defining the bottom of the stack and the successive elementary laminations being arranged above the first lamination, such that a first periodicity element of the periodic structure of each elementary lamination is disposed directly above a second periodicity element of the periodic structure of the underlying elementary lamination.

Advantageously, the number of elementary laminations is equal to the number of periodicity elements of the periodic structure in each structured section of each respective elementary lamination.

Preferably, each elementary lamination is angularly offset with respect to the following adjacent lamination, the angle of offset being determined by the periodicity of the periodic structure and the diameter of the outer circumference of the elementary lamination such that the angle of offset is n times the angle formed by two adjacent periodic elements having as apex the intersection of the central axis with the plane of the lamination, n being an integer number.

The invention also relates to a resolver comprising:
a rotor comprising at least one stack of laminations as described above,
a stator configured to receive the rotor, and
electrical connections configured to set up a variable electric field upon the rotation of the rotor with respect to the stator.

The invention also pertains to a rotary electric machine comprising
a rotor comprising at least one stack of laminations as described above,
a stator configured to receive the rotor, and
electrical connections configured to set up a variable electric field upon the rotation of the rotor with respect to the stator.

The invention also relates to a method for manufacturing a stack of laminations as described above, comprising the following steps:
the provision of a plurality of elementary laminations as described above,
the definition of a bottom lamination,
the stacking of a plurality of laminations coaxially on the bottom lamination, such that the first periodicity element of the periodic structure of each elementary lamination is disposed directly above the second periodicity element of the periodic structure of the underlying elementary lamination,
the clamping of the aligned stack,
the bonding of the stack onto the superimposed unstructured sections.

### BRIEF DESCRIPTION OF THE FIGURES

Other features and advantages of the invention will become apparent from the following detailed description, with reference to the appended drawings, on which:

FIG. 1 is a top view of an elementary lamination according to the invention.

FIG. 2 is a magnification of a portion of the elementary lamination of FIG. 1.

FIG. 3 is a perspective view of an elementary lamination according to the invention.

FIG. 4 is a perspective view of a stack of laminations according to the invention in the process of being manufactured.

FIG. 5 is a perspective view of a stack of laminations according to the invention.

FIG. 6 illustrates a simplified embodiment to explain the stacking principle.

FIG. 7 illustrates a variable-reluctance resolver.

FIG. 8 illustrates a rotary machine including a variable-reluctance resolver.

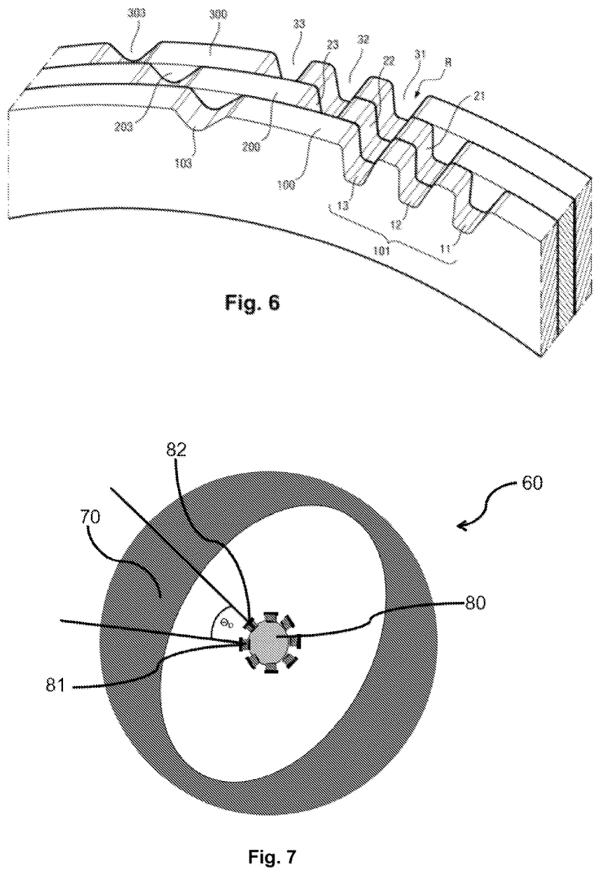

For reasons of clarity of the figures, the different elements have not necessarily been drawn to scale. In particular, the thicknesses of the elementary laminations and the spacing between the laminations on FIG. 6 have been exaggerated.

### DETAILED DESCRIPTION OF EMBODIMENTS

### Overview of the Elementary Lamination

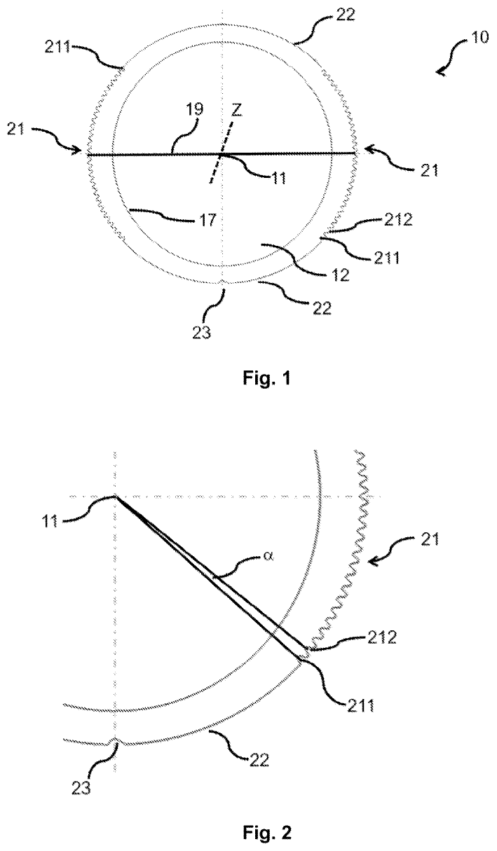

FIG. 1 illustrates an elementary lamination according to the invention. The elementary lamination 10 has the geometry of a flat disc, the outer perimeter of which is essentially circular. The outer circumference of the disc defines an outer diameter 19 and a center 11 of the elementary lamination 10. A central axis Z of the elementary lamination passing through the center 11 is perpendicular to the flat disc. The disc preferably has an inner hollow.

A peripheral portion of the elementary lamination comprises at least one periodic structure 21 comprising a succession of periodicity elements. In a preferred embodiment, the peripheral portion is the outer edge of the disc. In other embodiments, the disc includes an inner hollow and the peripheral portion is the inner edge of the hollow disc.

With reference to FIG. 2, two successive periodicity elements 211, 212 and the center 11 of the circumference describe an angle of periodicity a. Two successive periodic elements are not necessarily placed directly beside one another. For example, when the periodic structure is a succession of identical slots, each n-th slot may for example be considered as a periodic element, n being an integer number. Thus, the angle of offset α is n times the angle formed by two adjacent periodic elements 211, 212. The apex of the angle is still the center of the elementary lamination, i.e. the intersection of the central axis (X) with the plane of the lamination.

In this case, the intermediate slots between two periodic elements are considered as belonging to the preceding periodic element. In this case, the angle of periodicity a is defined by the slots considered as periodic elements and the center of the circumference of the elementary lamination.

One may thus define a periodicity corresponding to a definite number of increments in the periodic structure, for example a defined number of teeth or slots. This makes it possible to manufacture a quantity of identical laminations, to choose different increments and consequently to use these laminations for stacks that have different angles of offset. This makes it possible to facilitate the manufacturing processes and pool equipment and software for stacks of laminations for different devices.

Preferably, the periodic structure 21 extends solely over a part of the circumference of the elementary lamination 10 and does not cover the entire circumference. A first periodicity element 211 of each periodic structure 21 defines the start of the periodic structure 21. When stacking several elementary laminations 10, the first periodicity element 211 may be used as a reference element to identify the position of one elementary lamination 10 with respect to another lamination in the same stack. The first element may be chosen on the right-hand side or on the left-hand side of the periodic structure. In the case of a periodic structure 21 comprising recesses and elevations, the first recess is typically chosen as the reference element.

The outer edge of the elementary lamination may comprise only one or several periodic structures 21. If there are several periodic structures 21 on one lamination, all the periodic structures are identical in terms of numbers of periodicity elements. In general, the same shape will be chosen for all the periodic structures on one and the same sheet, in order to facilitate the manufacturing of the lamination. Typically, an elementary lamination has two periodic structures on two opposite areas on the perimeter of the disc. Such an arrangement makes it possible to use two retaining and shimming tools on opposite faces of the stack during the bonding, which will be described below. Thus, the two tools exert opposing forces on the stack of laminations, which makes it possible to stabilize the superimposition of the elementary laminations. The fact of using two periodic structures and not further increasing the number of identical structures moreover makes it possible to design relatively long structures each comprising a large number of periodicity elements. Such long structures make it possible to embody wide angles of offset between the first and the last elementary lamination in a stack of laminations.

Advantageously, the periodic structure 21 is flush with the outer perimeter of the lamination in order to reduce the bulk of the rotor in which the elementary lamination will be used. Preferably, the periodic structure 21 comprises recesses extending radially toward the center 11 of the hollow disc. Such a recess is suitable for the insertion therein of a key or another retaining and shimming tool during the stacking of several elementary laminations.

One typically chooses a periodic structure which is easy to produce with the cutting tools available for cutting out a metal sheet, with known and standardized geometry and tolerances. For example, the periodic structure can be a tooth set of a gear, which is a known structure and often used in the metal processing industry. This facilitates manufacturing since the tools and software for producing the structure are generally already available and the tolerances are controlled. The documentation and communication of technical specifications is also simplified since it is a known structure already described in the available technical standards and documents.

Each elementary lamination 10 further comprises one or more unstructured sections 22 over its circumference, which sections can be essentially smooth. When stacking a plurality of laminations, the unstructured section 22 is used as an area of bonding of the stack. Moreover, the transition between an unstructured section 22 and a section comprising a periodic structure 21 defines the first periodicity element 211 which is the periodic element closest to the unstructured section 22.

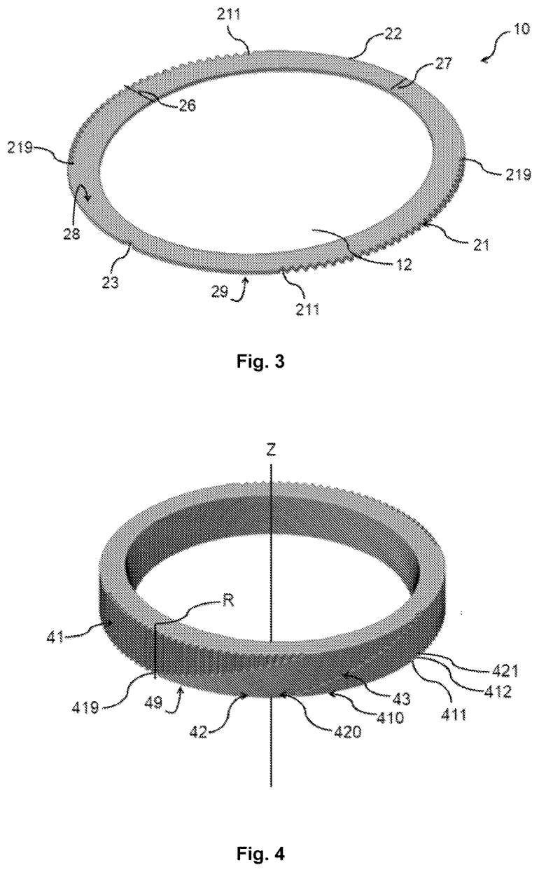

The outer edge of the elementary lamination may further comprise an orientation slot 23 which is arranged in an unstructured section 22 on the circumference of the lamination and oriented in the direction of the center 11 of the elementary lamination 10. With reference to FIG. 3, the orientation slot 23 makes it possible to identify the direction of cutting of the elementary lamination 10, i.e. to identify an upper surface 28 and a lower surface 29, by way of its shape and/or its position. For example, the orientation slot 23 may be asymmetrical and/or it may be closer to a periodic structure 21 on one side than to the periodic structure 21 on the other side. Thus, it is possible to orient the upper faces 28 and the lower faces 29 of several elementary laminations 10 intended to be stacked in the same direction, and thus to orient any burrs and/or cutting edges and/or other protruding areas in the same direction, which facilitates the production of a regular stack in which the laminations 10 are laid flat on top of one another.

The elementary lamination 10 preferably has an inner hollow 12 which can have the shape of a circle, an oval, an ellipse or any other regular or irregular geometry. Preferably, the hollow 12 has a discrete rotational symmetry about the center 11 of the disc. More preferably, it has a rotational symmetry of 180°, i.e. the shape of the inner hollow 12 is contiguous with itself if rotated by 180° about the center 11 of the circle.

If the hollow 12 has a non-circular geometry, the hollow 12 and the outer circumference of the elementary lamination 10 define at least one wide area 26 and at least one narrow area 27 of the hollow disc. Preferably, the elementary lamination 10 has two wide areas 26 and two narrow areas 27.

Advantageously, the at least one section having a periodic structure 21 is arranged at a wide area 26 and the at least one unstructured section 22 is arranged in a narrow area 27 of the hollow disc. One thus avoids the generation of harmonics and further increases the accuracy of the variable-reluctance resolver.

The elementary lamination is typically cut out from a laminated metal sheet of a thickness between approximately 0.1 and 0.35 mm. Preferably, the lamination is cut out of a rolled sheet made of ferromagnetic material having a small hysteresis cycle, for example an alloy comprising iron and nickel or ferrosilicon. Preferably, the rolled sheet includes a layer of electrical insulation such as an oxide layer or another layer made of an electrical insulator over at least one face. The cutting-out can be done by stamping with a tool having the geometry of the elementary lamination, or by an electrical discharge machining process in which the electron beam is guided by way of a software program into which the geometry of said elementary lamination is inputted. The cutting-out of the outer edge and the hollow can be done in one or more steps. Typically, the cutting-out of the periodic structure is done during the same step as the cutting-out of the other portions of the outer edge, to simplify the manufacturing and perform it more quickly. All the elementary laminations intended to form a stack together have identical shapes and are manufactured from the same type of sheet metal. This makes it possible to further reduce the need for equipment and tools, and the time and cost of manufacturing.

### Production of a Stack of Laminations

A description will now follow of the stacking of a plurality of identical elementary laminations, as described above, in order to obtain a helical stack intended to form the rotor of a variable-reluctance resolver. The number of laminations to form a rotor is typically between 5 and 100 laminations. Advantageously, the shape of the elementary laminations is chosen such that the number of periodic elements in each periodic structure is equal to the number of laminations in the stack.

With reference to FIG. 4, a first elementary lamination 40 intended to form the bottom of the stack is chosen. The first lamination 40 is laid on its back face 49. It has one or more unstructured areas 42 and can have an orientation slot 43. The central axis Z is oriented vertically. Each first periodic element 411 is arranged directly beside an unstructured area 42.

According to the helical direction of the desired angular offset for the stack to be produced, one chooses the first periodic element 411 on the right-hand side or on the left-hand side of a structure. If one wishes for the upper laminations to be angularly offset in the clockwise direction, the first periodic element 411 is situated on the left-hand side of each periodic structure, as illustrated in FIG. 4. For an offset of the laminations in the reverse direction, one may choose the first periodic element on the right-hand side of the periodic structure, such as for example illustrated in FIG. 6.

A second elementary lamination 420 is then laid above the first elementary lamination 410, in such a way that the central axis of the second elementary lamination 420 coincides with the central axis Z of the first elementary lamination 410. If the elementary laminations include an orientation slot 43, the second elementary lamination 420 is oriented in the same direction as the first elementary lamination 410 using the respective orientation slots, and the unstructured section of the second elementary lamination 420 in which the orientation slot 43 is arranged is positioned above the unstructured section in which the orientation slot of the first elementary lamination 410 is arranged.

To provide the desired angular offset, the first periodicity element 421 of the second lamination 420 is positioned directly above the periodicity element 412 of the bottom lamination 410. Thus, the second elementary lamination 420 is angularly offset by an angle α with respect to the bottom elementary lamination 410. The respective orientation slots have an equivalent angular offset.

Other laminations are then laid in the same way on top of the second elementary lamination. The central axis of each lamination coincides with the central axis Z of the first elementary lamination 410 and the central axis of the other elementary laminations. Each successive lamination is oriented using the orientation slot and the laminations are stacked in such a way as to make their central axes Z coincide and to superimpose the unstructured areas in which the respective orientation slots are arranged.

Each successive lamination is oriented so as to position each of its first periodic elements over one and the same periodic element of the underlying elementary lamination. If there are several periodic structures present on the outer edge of the elementary laminations, each periodic structure is positioned over the equivalent periodic structure with respect to the orientation slot of the underlying lamination. Thus, each lamination is angularly offset by an angle α with respect to the underlying lamination. If the periodic structure 41 is a tooth set, each respective elementary lamination is offset by one tooth with respect to the elementary lamination directly beneath it.

The succession of respective orientation slots 43 forms a twisted path on the outside of the stack. This twisted path allows the user to quickly check the regularity of the stack by visual inspection.

In an advantageous embodiment, the number of periodicity elements in each periodic structure is equal to the number of elementary laminations in the stack. That is to say, if a periodic structure of each elementary lamination has a succession of n periodicity elements, the number of stacked laminations is equal to n, n being an integer number.

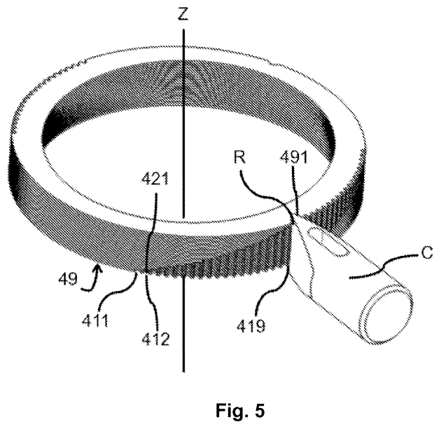

With reference to FIG. 5, in the finished stack the first periodic element 491 of the last lamination is positioned above the last periodic element 419 of the bottom lamination. One thus obtains, for each section with a respective periodic structure, a superimposition of a single periodic element per elementary lamination extending between the bottom lamination and the last lamination at the top of the stack, forming a vertical groove R which is continuous over the height of the stack. The groove R may receive a positioning key C during the stacking method.

The laminations are stacked helically. The last lamination is angularly offset from the bottom lamination by an angle n*α equivalent to the number n of elementary laminations multiplied by the angle α of offset defined by two periodic elements.

FIG. 6 illustrates the principle of offset stacking for a simple embodiment in which the periodic structure comprises three periodicity elements configured for the stacking of three elementary laminations. To better visualize the stack and the slot, the bottom lamination is shown in the first plane and the third and last lamination in the background of the figure. In this example, the periodic structure is a succession of approximately rectangular recesses. The first elementary lamination 100 comprises a periodic structure 101 comprising a first periodic element 11, a second periodic element 12 and a third periodic element 13. The first elementary lamination 100 is oriented using the orientation slot 103 arranged in the unstructured section 102 of the outer edge.

The second elementary lamination 200 is oriented using the orientation slot 203. The periodic structure of the second elementary lamination comprises a first periodicity element 21 which is positioned directly above the second element 12 of the first elementary lamination. Thus, the second periodic element 22 of the second elementary lamination 200 is positioned directly above the third periodic element 13 of the first elementary lamination 100. The third periodic element 23 of the second elementary lamination 200 is positioned above the unstructured section 102 of the first elementary lamination 100.

In the same way, the third elementary lamination 300 is oriented using an orientation slot 303 and positioned above the second elementary lamination. The first periodic element 31 of this third elementary lamination is positioned directly above the second element 22 of the second elementary lamination 200. The second periodic element 32 of the third elementary lamination 300 is positioned directly above the third periodic element 23 of the second elementary lamination 200, which is itself arranged above the unstructured section 102. The third periodic element 33 of the third elementary lamination 300 is positioned above the unstructured section 202 of the second elementary lamination 200.

The stack therefore has a single vertical superimposition of periodic elements which is continuous from the top to the bottom of the stack, formed by the slots 13, 22 and 31. This superimposition forms a single vertical groove R in the stack of the periodic structures of each respective elementary lamination. The other periodic elements are all arranged either above or below at least one unstructured section of an elementary lamination.

Similarly, in a stack of a large number of laminations, a single vertical groove is obtained when the number of periodic elements is equal to the number of elementary laminations, and each first periodic element is laid directly above a second periodic element of the underlying lamination, for all the elementary laminations in the stack except for the bottom lamination.

If there are several periodic structures per lamination, a number of vertical grooves is obtained equivalent to the number of periodic structures per elementary lamination. Each vertical groove extends from a first element of a periodic structure of the elementary lamination from the top all the way to the last element of the corresponding periodic structure of the bottom elementary lamination.

To stabilize the stack of laminations, a retaining and shimming tool is inserted, typically a positioning key, into each continuous vertical groove between the bottom lamination all the way to the last lamination. The insertion of the tool also makes it possible to finely adjust the angular position of the elementary laminations in the stack for bonding. Better stabilization is obtained when two or more keys are used, arranged symmetrically with respect to the stack axis Z. Typically, two keys are used for an assembly of two sections with periodic structure per elementary lamination. Such straight keys are easy to manufacture since they have the geometry of a simple shim. The positioning of the keys is easy since they are inserted into a straight, not a twisted, vertical groove.

One can now attach the keys and, if necessary, clamp the stack in the vertical direction using a mechanical device such as a screw. Subsequently the stack of laminations can be bonded. Preferably, a suitable adhesive is applied to the outsides of the unstructured sections of the respective elementary laminations. The clamping and bonding are facilitated by the horizontal positioning of the retaining and shimming tool, since this tool occupies only a very limited space on the perimeter of the stack.

The configuration using straight keys thus allows for a simplified bonding on the unstructured areas of the stack.

The stack of laminations, thus finished, can be used for the manufacturing of a rotor for a resolver, for example a variable-reluctance resolver. In other embodiments, such a stack is intended for the manufacturing of a rotary electric machine, for example an electric motor. In some scenarios, several stacks are combined to form a single rotor. The rotor can then be assembled with a stator and equipped with electrical connections to form a variable-reluctance resolver.

Those skilled in the art will know how to adapt the dimension of the periodic structure according to the technical specifications of the stack. If the periodic structure is a tooth set, one will choose the diameter, the modulus, the tooth offset and the number of teeth according to the height and angular offset of the desired stack. By adjusting the parameters of the periodic structure, angles of offset of all sizes can be embodied. Very large angles of offset can thus be embodied, but also small angular offsets or even stacks with no angular offset.

FIG. 7 illustrates a variable-reluctance resolver 60 comprising an inner stator 80 surrounded by a rotor 70. The stator includes a plurality of teeth carrying windings. Two adjacent teeth of the stator form a tooth angle of Θ_{D} with the central axis X. If the stack of elementary laminations is used for such a rotor 70, the angle of offset α will also be chosen according to the tooth set of the stator. In general, the angle of offset α between two elementary laminations or two packets of laminations is equal to the tooth angle Θ_{D} of the stator, multiplied by (N−1)/N, N being the number of elementary laminations or, where applicable, cores of laminations, of the rotor:

$$α = {θ}_{d} \frac{( N - 1 )}{N}$$

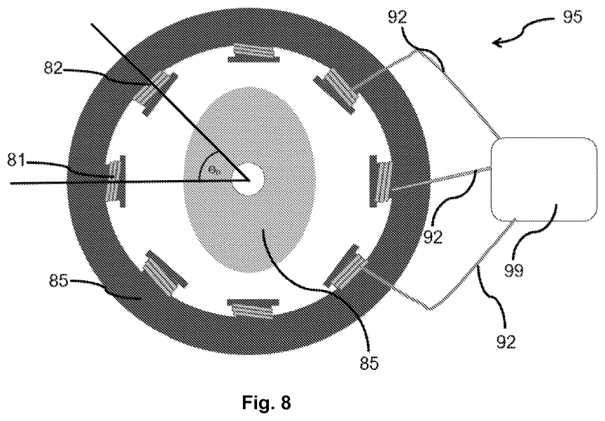

FIG. 8 illustrates a rotary machine 95 comprising a variable-reluctance resolver comprising an outer stator 85 and a central rotor 75. For such a resolver, the same relationship between the angle of offset α between the laminations and the tooth angle Θ_{D} of the stator is applicable. The rotary machine 95 further comprises electrical connections 92 configured to set up a variable electric field upon the rotation of the rotor with respect to the stator. This variable electric field is typically generated by a voltage generator 95.

1. An elementary lamination in the shape of a disc, wherein a peripheral portion of said elementary lamination comprises at least one structured section having a periodic structure comprising a succession of periodicity elements, said periodic structure being configured to align said elementary lamination in a helical stack of laminations,
the peripheral portion further comprising at least one unstructured section, an orientation slot being arranged in the at least one unstructured section, said orientation slot being asymmetrical and/or closer to a periodic structure on a first side of said unstructured section than to the periodic structure on a second side opposite the first side of said unstructured section.

2. The elementary lamination as claimed in claim 1, wherein the periodic structure comprises recesses extending in a radial direction of the disc.

3. The elementary lamination as claimed in claim 1, wherein the peripheral portion comprising the at least one structured section is the outer edge of the disc.

4. The elementary lamination as claimed in claim 1, further comprising an inner hollow, wherein the peripheral portion comprising the at least one structured section is the inner edge of the hollow disc.

5. The elementary lamination as claimed in claim 1, comprising two structured sections having a periodic structure, and two unstructured sections.

6. A stack of laminations comprising a plurality of elementary laminations as claimed in claim 1 stacked coaxially, a first elementary lamination defining the bottom of the stack and successive elementary laminations being arranged above the first lamination, such that a first periodicity element of the periodic structure of each elementary lamination is disposed directly above a second periodicity element of the periodic structure of the underlying elementary lamination.

7. The stack of laminations as claimed in claim 6, wherein the number of elementary laminations is equal to the number of periodicity elements of the periodic structure in each structured section of each respective elementary lamination.

8. The stack of laminations as claimed in claim 6, wherein each elementary lamination is angularly offset with respect to the following adjacent lamination, an angle of offset being determined by a periodicity of the periodic structure and a diameter of the outer circumference of the elementary lamination such that the angle of offset is n times the angle formed by two adjacent periodic elements having as apex the intersection of the central axis with the plane of the lamination, n being an integer number.

9. A resolver comprising:
a rotor comprising at least one stack of laminations as claimed in claim 6,
a stator configured to receive the rotor, and
electrical connections configured to set up a variable electric field upon the rotation of the rotor with respect to the stator.

10. A rotary electric machine comprising:
a rotor comprising at least one stack of laminations as claimed in claim 6,
a stator configured to receive the rotor, and
electrical connections configured to set up a variable electric field upon the rotation of the rotor with respect to the stator.

11. A method for manufacturing a stack of laminations as claimed in claim 8, comprising the following steps:
providing a plurality of elementary laminations as claimed in claim 1,
defining of a bottom lamination,
stacking of a plurality of laminations coaxially on the bottom lamination, such that a first periodicity element of the periodic structure of each elementary lamination is disposed directly above a second periodicity element of the periodic structure of an underlying elementary lamination,
clamping of the aligned stack,
bonding of the stack onto the superimposed unstructured sections.
